(19) United States
(12) Patent Application Publication
(10) Pub. No.: US 2001/0040008 A1
(43) Pub. Date: Nov. 15, 2001

(54) POLYMER DISPERSIONS SUITABLE FOR REACTIVE SYSTEMS

(76) Inventors: HANS BAURIEDEL, DUESSELDORF (DE); WOLFGANG KLAUCK, MEERBUSCH (DE); GUENTER HENKE, NEUSS (DE)

Correspondence Address: HENKEL CORPORATION, 2500 RENAISSANCE BLVD, STE 200, GULPH MILLS, PA, 19406, US

(21) Appl. No.: 08/122,417

(22) PCT Filed: Mar. 13, 1992
(86) PCT No.: PCT/EP92/00560

§ 371 Date: None

(30) Foreign Application Priority Data
Mar. 13, 1992 (US) PCT/EP92/00560
Mar. 22, 1991 (DE) P 41 09 477.8

(51) Int. Cl. C08K 3/20; C09J 1/00

(52) U.S. Cl. 156/327; 524/591

(57) ABSTRACT

The invention relates to aqueous polymer dispersions suitable as reactive resin component (A) for a two-component reactive system. To obtain reactive systems which can be produced without solvents and which, in addition, combine good adhesion values with excellent optical properties of the laminates, good substrate wetting, high initial tack and high water resistance of the laminates, the dispersion is characterized in that at least 20% by weight of the polymer content emanates from an aqueous dispersion of OH-functional polyurethane prepolymers obtainable by reaction of

a polyol component (I) containing polyester polyols and

compounds containing at least two isocyanate-reactive groups and, in addition, groups capable of salt formation (II) with

a stoichiometric excess of an isocyanate component (III) consisting of at least 20% by weight tetramethyl xylylene diisocyanate (TMXDI),

subsequent dispersion in water and

at least partial reaction of the remaining NCO groups with aminoalcohols (IV) and

if desired, subsequent chain extension.

This invention relates to an aqueous polymer dispersion suitable as a reactive resin component for a two-component reactive system, to a process for the production of such systems and to their use.

Polyurethane dispersions and processes for their production in the presence or absence of solvents as dispersion aids are known to the expert and have been described in numerous publications, cf. DE-OS 39 03 796, EP 0 272 566, EP 0 312 890, GB 2,104,085 and EP 0 354 471. The use of aqueous polyurethane dispersions for the production of laminates is also described in the patent literature. Thus, JP 60212455 describes a polyurethane system prepared from a polyether polyol as the polyol component, N-methyl diethanolamine as the isocyanate-reactive compound containing a salt-forming group and xylylene diisocyanate (XDI) as the isocyanate component. In this case, a polyfunctional epoxide compound, namely sorbitol polyglycidyl ether, is used to cure the system. EP 0 126 297 describes a system in which the polyurethane component may be prepared, for example, from OH-functional neopentyl glycol/hexanediol adipate, dimethyl propionic acid (DMPA) and tolylene diisocyanate (TDI) and may then be chain-extended with aminoethyl ethanolamine. These prepolymers of necessity contain certain reactive amino or semicarbazide groups. Bisphenol A diglycidyl ether, for example, was used to cure this system in the production of laminates. There is also no reference to the fact that, if desired, these systems may be produced free from solvent.

The prior art literature on polyurethane dispersions mentions several starting compounds, for example OH-functional adipates as polyester polyols and DMPA as an internal emulsifier (EP 0 126 297), tetramethyl xylylene diisocyanate (TMXDI) and other isocyanates (hitherto unpublished German patent application P 40 11 455), and also the reaction with aminoalcohols and chain extension with water (EP 0 354 471). The various methods of dispersion and also water-dispersible polyisocyanates and epoxides also belong to the prior art. Despite this detailed knowledge of starting materials and processes, it has not yet been possible to produce special polyurethane dispersions suitable for use as a resin component for two-component reactive systems, for example as film laminating adhesives, which meet the special requirements that reactive systems such as these have to satisfy.

One of these requirements is the momentary tackiness of the film formed from the dispersion after drying. This temporary initial tackiness, which disappears again through further reaction with the second reactive component (B), enables the substrate to be wetted over its entire surface area. This applies in particular at lamination temperatures below 60° C.

High contact adhesion values are a prerequisite for any laminating adhesive. These high contact adhesion values should be produced both over the surfaces to be bonded and also in the sealing zone after welding of the particular thermoplastic inner layers involved in the laminate. In terms of order of magnitude, a peel strength of 4 newton and more per 15 mm strip width for a crosshead speed of 100 mm/min. is required in the first case while, for polyolefin films for example, a peel strength of 30 newton and more per 15 mm strip width for a crosshead speed of, again, 100 mm/min. is required in the second case, depending on the structure of the laminate.

Among the other requirements are perfect optical properties of the laminate, which include transparency in the case of laminated plastic films and also structural fineness in the case of laminated aluminium foils. Low monomer contents and, preferably, the complete of absence of monomers from the residue formed after the removal of water from the dispersion are required, above all, for laminated films to be used for food packaging purposes. Such monomers may possibly undergo migration which is undesirable. In addition, the reactive systems should be at least substantially free from solvents inter alia for reasons of safety in use during processing. The laminates produced are also required to be highly water-resistant. In addition, the dispersions according to the invention should be universally useable, i.e. the corresponding reactive systems should be suitable not only for bonding, but also for coating. In addition, the polymer dispersion should be constituted in such a way that more than one reaction mechanism is available for curing in corresponding reactive systems.

The problem addressed by the present invention was to provide water-based film laminating adhesives which would be suitable as a reactive resin component for two-component reactive systems and which would satisfy the requirements stated above.

This problem has been solved by an aqueous polymer dispersion suitable as reactive resin component (A) for a two-component reactive system, characterized in that at least 20% by weight of the polymer content emanates from an aqueous dispersion of OH-functional polyurethane prepolymers obtainable by reaction of

a polyol component (I) containing polyester polyols and

compounds containing at least two isocyanate-reactive groups and, in addition, groups capable of forming salts (II)

a stoichiometric excess of an isocyanate component (III) consisting of at least 20% by weight tetramethyl xylylene diisocyanate (TMXDI),

subsequent dispersion in water and

at least partial reaction of the remaining NCO groups with aminoalcohols (IV) and

if desired, subsequent chain extension.

The resin component (A) may contain up to 80%, based on solids, of polymers which do not correspond to the OH-functional polyurethane prepolymers described hereinafter. Particularly suitable polymers of the type in question are polymers based on acrylic compounds, i.e. acrylates and methacrylates. In addition to the homopolymers, copolymers and terpolymers are also suitable. Polymers of other acrylic compounds, such as acrylonitrile for example, may also be suitable. Vinyl acetate, SBR latices and vinyl alcohol in particular are mentioned as other suitable polymers. Although good results can be obtained with a polymer content of 20% by weight polyurethane prepolymers in the dispersion, the content of the prepolymers preferably exceeds 50 or even 70% by weight. In one particular embodiment, no other polymers apart from the polyurethane prepolymers are present in the dispersion.

The polyester polyols present in the polyol component (I) are preferably based at least predominantly on adipic acid and/or phthalic acid as starting material. Mixed esters of the two acids mentioned are also suitable. Pure polyadipates or polyphthalates and mixtures thereof are particularly suitable. Particularly good results are obtained if, in addition, the polyester polyols mentioned are based on glycol homologs containing ether oxygen as the alcohol component.

The polyester polyols mentioned are preferably present in (I) in a quantity of at least 50% by weight and preferably in a quantity of at least 75% by weight. In a particularly preferred embodiment, they are used without significant further additions. Suitable polyester polyols are also described in DE 37 35 587. These polyester polyols are in particular the homologs which can be formally obtained by addition of alkylene oxides. Adducts of ethylene oxide, propylene oxide and/or butylene oxide are particularly mentioned. Diethylene glycol is particularly suitable.

Accordingly, up to 50% by weight, but preferably less, of the polyester polyols on which the polyurethane dispersions used in accordance with the invention are based can be replaced by other polyols typically found in such preparations. In exactly the same way as the polyester polyols, these other polyols must quite generally contain at least two isocyanate-reactive hydrogen atoms and should be at least substantially linear. Suitable other polyols are, for example, polyethers, polyacetals, polycarbonates, polythioethers, polyamides, polyester amides and/or other polyesters which contain on average two to at most four reactive hydrogen atoms. In special cases, it can be of advantage to add higher polyols, more particularly tri-functional polyols, to the predominantly difunctional polyols. The degree of precrosslinking can be varied in dependence upon the quantity in which they are added.

In the context of the invention, polycarbonates are understood to be polyesters which, theoretically, may be prepared by esterification of carbonic acid with dihydric or higher alcohols and which contain a hydroxyl group at either end of the chain. The alcohols and, hence, ultimately the polycarbonate diols preferably have an aliphatic structure. Suitable higher alcohols are, for example, trihydric alcohols, such as glycerol. However, it is preferred to use dihydric alcohols, particularly if they contain not less than 4 and not more than 10 carbon atoms. Although cyclic and branched-chain alcohols are suitable, linear alcohols are preferred. The hydroxyl groups may be arranged adjacent one another, for example in the 1,2-position, or may even be isolated. Diols containing terminal OH groups are preferred.

Suitable polyethers are, for example, the polymerization products of ethylene oxide, propylene oxide, butylene oxide and also copolymerization or graft polymerization products thereof and the polyethers obtained by condensation of polyhydric alcohols or mixtures thereof and those obtained by alkoxylation of polyhydric alcohols, amines, polyamines and aminoalcohols. Other suitable polyethers are the polytetrahydrofurans described in EP 354 471 cited above and also ethylene glycol-terminated polypropylene glycols.

Suitable polyacetals are, for example, the compounds obtainable from glycols, such as diethylene glycol, triethylene glycol, hexanediol and formaldehyde. Suitable polyacetals can also be obtained by polymerization of cyclic acetals.

Among the polythioethers, the condensation products of thiodiglycol on its own and/or with other glycols, dicarboxylic acids, formaldehyde, aminocarboxylic acids or aminoalcohols are mentioned in particular. Depending on the co-components, the products in question are polythioethers, polythio mixed ethers, polythioether esters, polythioether ester amides. Polyhydroxyl compounds such as these may also be used in alkylated form or in admixture with alkylating agents.

The polyesters, polyester amides and polyamides include the predominantly linear condensates, for example polyterephthalates, obtained from polybasic, saturated and unsaturated carboxylic acids or anhydrides thereof and polyhydric, saturated and unsaturated alcohols, amino-alcohols, diamines, polyamines and mixtures thereof. Polyesters of lactones, for example caprolactone, or of hydroxycarboxylic acids may also be used. The polyesters may be terminated by hydroxyl or carboxyl groups. Relatively high molecular weight polymers or condensates, such as for example polyethers, polyacetals, polyoxymethylenes, may also be used as alcohol component in their synthesis.

Polyhydroxyl compounds already containing urethane or urea groups and optionally modified natural polyols, such as castor oil, may also be used. It is also possible in principle to use polyhydroxyl compounds containing basic nitrogen atoms, for example polyalkoxylated primary amines or polyesters or polythioethers containing co-condensed alkyl diethanolamine. Polyols which can be obtained by complete or partial ring opening of epoxidized triglycerides with primary or secondary hydroxyl compounds, for example the reaction product of epoxidized soybean oil with methanol, may also be used. copolymers of the polyhydroxyl compounds mentioned are also suitable as are their analogs preferably terminated by amino or sulfide groups.

The polyols mentioned above, more particularly the polyester polyols, preferably have an average molecular weight in the range from 300 to 5,000 and, more preferably, in the range from 500 to 3,000. These figures represent number average molecular weight ranges which can be calculated via the OH value.

Component (II)—also called an internal emulsifier—reacted with the polyol component (I) and the isocyanate component (III) is a compound which contains at least two isocyanate-reactive groups and, in addition, at least one other group capable of salt formation. The salt-forming group is preferably a carboxylic acid, a sulfonic acid or an ammonium compound. Dihydroxy compounds or even diamino compounds containing an ionizable carboxylic acid, sulfonic acid or ammonium group may be used for this purpose. These compounds may either be used as such or may be prepared in situ. Carboxylic acid derivatives, sulfonic acid diamines and/or amino diols are preferred. To introduce compounds containing ionizable carboxylic acid groups into the polyurethane, the expert may add to the polyols special dihydroxycarboxylic acids which are only capable to a limited extent, if at all, of secondary reactions of the carboxyl groups with the isocyanate groups. These special dihydroxycarboxylic acids are, in particular, carboxylic acid diols containing between 4 and 10 carbon atoms. Dimethylol propionic acid (DMPA) is a preferred dihydroxycarboxylic acid or carboxylic acid diol.

In order to introduce sulfonic acid groups capable of salt formation, a diaminosulfonic acid may be added to the polyols. Examples are 2,4-diaminobenzenesulfonic acid and also the N-(ω-aminoalkane)-ω′-aminoalkanesulfonic acids described in DE 20 35 732.

In order to introduce ammonium groups capable of salt formation into the polymer, the polyurethane prepolymer may also be modified with an aliphatic and aromatic diamine in accordance with DE 15 95 602 in such a way that primary amino groups are positioned at the chain ends and may then be converted into quaternary ammonium compounds or into amine salts with typical alkylating agents.

The polymers are preferably present in salt form in the polyurethane prepolymer dispersions used in accordance with the invention. In the preferred polymers modified with carboxylic acids or sulfonic acids, alkali metal salts, ammonia or amines, i.e. primary, secondary or tertiary amines, are preferably present as counterions. In the cationically modified products, acid anions, for example chloride, sulfate or the anions of organic carboxylic acids, are present as counterions. The groups capable of salt formation may therefore be partly or completely neutralized by the counterions. An excess of neutralizing agent may also be used.

Aminodiols, preferably diethanolamine, may also be used as the compounds of component (II) containing an ionizable ammonium group. The suitable compounds mentioned as component (II) may of course also be used in admixture with one another. Compounds such as these are also described in GB 2,104,085 and in DE 36 43 791.

It has been found that, for perfect optical properties of the laminate (apart from such factors as absence of foam, good film wetting and good drying properties during processing in laminating machines), it can be of advantage in one preferred embodiment for the polyurethane dispersions used to be so finely divided that they represent an optically opaque system. Dispersibility can be increased with increasing content of internal emulsifiers, such as carboxylic acid diols, more particularly DMPA. On the other hand, the internal emulsifiers may also be regarded in this connection as hard segment formers which, with increasing content, lead to a reduction in initial tackiness (also known as tack). Any such reduction in tack is undesirable in the present systems, as mentioned at the beginning. The measures which lead to an improvement in the desired properties, i.e. high tack coupled with good optical quality, conflict with one another in this respect.

In one particular embodiment, the solution to this problem, as provided by the invention, is characterized in that the content of (II) in the polyurethane prepolymer is 1 to 13% by weight, preferably 2 to 8% by weight and, more preferably, 3 to 6% by weight based on the solids content. A relatively small quantity of dihydroxycarboxylic acids, more particularly DMPA, has the advantage that their neutralization, for example with sodium hydroxide, is accompanied by the formation of correspondingly small quantities of basic salts which can have a positive effect on the storage life of such systems. In addition, relatively high resistance of the cured adhesive to water can be obtained inter alia through the comparatively small percentage content of (II). Good to very good properties of the system can be achieved in particular when, in addition to the relatively small quantities of (II) mentioned, polyester polyols based essentially on glycols containing ether oxygen as alcohol component are present in (I). Polyester polyols based at least predominantly on diethylene glycol as the diol component are particularly suitable.

The polyfunctional isocyanate component on which the polyurethane dispersions are based consists completely or partly of α,α,α,α-tetramethyl xylylene diisocyanate (TMXDI). The meta-isomeric form is particularly suitable. Only with a minimum percentage content of around 20% by weight TMXDI in the isocyanate mixture is it possible to obtain a polyurethane dispersion suitable as a film laminating adhesive in accordance with the invention with a polyol component based on polyester polyols. At least 30% by weight and, better yet, at least 50% by weight of the isocyanate mixture consists of TMXDI. A rule of thumb in this regard is that the viscosity-governed handling properties of the products or intermediate products in the production of the polyurethane prepolymers are better, the higher the percentage content of TMXDI in the isocyanate mixture. Accordingly, preferred isocyanate components (III) are those of which half or more, for example up to two thirds or three quarters, and preferably the entirety contain TMXDI. TMXDI is also occasionally called tetramethyl xylene diisocyanate.

Suitable additional polyisocyanates making up the balance to 100% by weight are any polyfunctional, aromatic and aliphatic isocyanates, such as for example 1,5-naphthylene diisocyanate, 4,4′-diphenyl methane diisocyanate (MDI), hydrogenated MDI (H₁₂MDI), trimethyl hexane diisocyanate (TMDI), xylylene diisocyanate (XDI), 4,4′-diphenyl dimethyl methane diisocyanate, di- and tetraalkyl diphenyl methane diisocyanate, 4,4′-dibenzyl diisocyanate, 1,3-phenylene diisocyanate, 1,4-phenylene diisocyanate, the isomers of tolylene diisocyanate (TDI), optionally in admixture, 1-methyl-2,4-diisocyanatocyclohexane, 1,6-diisocyanato-2,2,4-trimethylhexane, 1,6-diisocyanato-2,4,4-trimethyl hexane, 1-isocyanatomethyl-3-isocyanato-1,5,5-trimethyl cyclohexane, chlorinated and brominated diisocyanates, phosphorus-containing diisocyanates, 4,4′-diisocyanatophenyl perfluoroethane, tetramethoxybutane-1,4-diisocyanate, butane-1,4-diisocyanate, hexane-1,6-diisocyanate (HDI), dicyclohexyl methane diisocyanate, cyclohexane-1,4-diisocyanate, ethylene diisocyanate, phthalic acid bisisocyanatoethyl ester, polyisocyanates containing reactive halogen atoms, such as 1-chloromethylphenyl-2,4-diisocyanate, 1-bromomethylphenyl-2,6-diisocyanate, 3,3-bis-chloromethylether-4,4′-diphenyl diisocyanate. Sulfur-containing polyisocyanates are obtained, for example, by reaction of 2 mol hexamethylene diisocyanate with 1 mol thiodiglycol or dihydroxydihexyl sulfide. Other important diisocyanates are trimethyl hexamethylene diisocyanate, 1,4-diisocyanatobutane, 1,2-diisocyanatododecane and dimer fatty acid diisocyanate. Also of interest are masked polyisocyanates which allow the formation of self-crosslinking polyurethanes, for example dimeric tolylene diisocyanate, or polyisocyanates reacted, for example, with phenols, tertiary butanol, phthalimide, caprolactam.

In one particular embodiment, the isocyanate component partly contains dimer fatty acid isocyanate. Dimer fatty acid is a mixture of predominantly C₃₆ dicarboxylic acids which is prepared by thermal or catalytic dimerization of unsaturated C₁₈ monocarboxylic acids, such as oleic acid, tall oil fatty acid or linoleic acid. Dimer fatty acids have long been known to the expert and are commercially available. The dimer fatty acid can be reacted to dimer fatty acid isocyanates. Technical dimer fatty acid diisocyanate contains on average at least two and less than three isocyanate groups per molecule dimer fatty acid.

The isocyanates mentioned above may be used both individually and in admixture as an additive to TMXDI. Aliphatic diisocyanates, particularly cyclic or branched aliphatic diisocyanates, are preferred, isophorone diisocyanates (IPDI) being particularly preferred. Polyisocyanates suitable in admixture with TMXDI are, in particular, HDI, IPDI, XDI, TMDI, TDI, MDL and/or H₁₂MDI. Other suitable polyisocyanates are known from the patent literature, for example from DE 37 35 587.

With the above-mentioned contents of TMXDI, the polyurethane prepolymers can be produced with a smaller quantity of solvents than is used in known processes, for example in the acetone process. In one particular embodiment, the polyurethane prepolymers are produced with no solvent at all. It is possible in this way to ensure that the polymer dispersions according to the invention are low in solvent and preferably free from solvent.

The suitable polyfunctional isocyanates preferably contain on average two to at most four NCO groups. The quantities of polyol mixture (I) and of the mixture of polyfunctional isocyanates (III) are selected in such a way that a certain ratio of NCO-reactive groups to NCO groups (known as the NCO:OH addition ratio) is present. The isocyanate component is preferably present in a stoichiometric excess, but on the other hand does not exceed twice the quantity of NCO-reactive groups. A ratio of or below 1.7:1 is particularly favorable. At all events, the preferred and optimal range so far as the subsequent performance results are concerned is above 1:1.

According to the invention, the prepolymer formed by the reaction of components (I), (II) and (III) is reacted with aminoalcohols (IV), so that the NCO groups remaining in the prepolymer are at least partly reacted with (IV). Aminoalcohols containing a primary or secondary amino group are particularly suitable for this reaction of the NCO-terminated prepolymers, which is also known as back-addition. Compounds containing tertiary amino group may also be suitable. Low molecular weight aminoalcohols are preferred. Those containing between 2 and 40 carbon atoms and preferably 2 and 12 carbon atoms are particularly suitable. Suitable representatives are, for example, ethanolamine, diethanolamine, N-butyl ethanolamine, neopentanolamine and diglycol amine and also amino sugars. The isocyanate groups may be partly or completely reacted with the aminoalcohols mentioned. In this case, a preferred addition ratio of NCO to NHR groups is in the range from 1:1 to 1:0.1 and, more particularly, in the range from 1:0.8 to 1:0.2. R represents hydrogen (preferred) or alkyl or aralkyl. In one particular embodiment, monoaminoalcohols are exclusively used as (IV). Instead of the NCO groups in the prepolymer, the above-mentioned reaction with (IV) now at least partly gives polymer-bound hydroxyl groups with formation of urea groups. Subsequent chain extension is completely or partly suppressed in this way without any loss of functionality. Accordingly, the action of (IV) on the freshly formed dispersion gives a reaction product which, commensurate with the quantity of (IV) added, based on a material having the same NCO content in the original prepolymer, but subsequently chain-extended, has remained at a far lower molecular weight and shows a more clearly pronounced tack of the dried residue. This applies in particular where monoaminoalcohols have been used as (IV). Polyurethane prepolymers which contain no reactive nitrogen-containing groups and particularly no reactive amino or semicarbazide groups, can advantageously be produced in this way. If desired, the reaction with the aminoalcohols may be followed by chain extension.

Chain-extending agents containing reactive hydrogen atoms include:

the usual saturated and unsaturated glycols, such as ethylene glycol or condensates of ethylene glycol, butane-1,3-diol, butane-1,4-diol, butenediol, propane-1,2-diol, propane-1,3-diol, neopentyl glycol, hexanediol, bis-hydroxymethyl cyclohexane, dihydroxyethoxyhydroquinone, terephthalic acid bis-glycol ester, succinic acid di-2-hydroxyethyl amide, succinic acid di-N-methyl-(2-hydroxyethyl)-amide, 1,4-di-(2-hydroxymethylmercapto)-2,3,5,6-tetrachlorobenzene, 2-methylenepropane-1,3-diol, 2-methylpropane-1,3-diol;

aliphatic, cycloaliphatic and aromatic diamines, such as ethylenediamine, hexamethylenediamine, 1,4-cyclohexylenediamine, piperazine, N-methyl propylenediamine, diaminodiphenyl sulfone, diaminodiphenyl ether, diaminodiphenyl dimethyl methane, 2,4-diamino-6-phenyl triazine, isophoronediamine, dimer fatty acid diamine;

aminoalcohols, such as ethanolamine, propanolamine, butanolamine, N-methyl ethanolamine, N-methyl isopropanolamine;

aliphatic, cycloaliphatic, aromatic and heterocyclic mono- and diaminocarboxylic acids, such as glycine, 1- and 2-alanine, 6-aminocaproic acid, 4-aminobutyric acid, the isomeric mono- and diaminobenzoic acids, the isomeric mono- and diaminonaphthoic acids;

water.

Special chain-extending agents containing at least one basic nitrogen atom are, for example, mono-, bis- or polyalkoxylated aliphatic, cycloaliphatic, aromatic or heterocyclic primary amines, such as N-methyl diethanolamine, N-ethyl diethanolamine, N-propyl diethanolamine, N-isopropyl diethanolamine, N-butyl diethanolamine, N-isobutyl diethanolamine, N-oleyl diethanolamine, N-stearyl diethanolamine, ethoxylated coconut oil fatty amine, N-allyl diethanolamine, N-methyl diisopropanolamine, N-ethyl diisopropanolamine, N-propyl diisopropanolamine, N-butyl diisopropanolamine, C-cyclohexyl diisopropanolamine, N,N-diethoxylaniline, N,N-diethoxyltoluidine, N,N-diethoxyl-1-aminopyridine, N,N′-diethoxylpiperazine, dimethyl-bis-ethoxylhydrazine, N,N′-bis-(2-hydroxyethyl)-N,N′-diethylhexahydro-p-phenylenediamine, N-12-hydroxyethyl piperazine, polyalkoxylated amines, such as propoxylated methyl diethanolamine, compounds such as N-methyl-N,N-bis-3-aminopropyl amine, N-(3-aminopropyl)-N,N′-dimethyl ethylenediamine, N-(3-aminopropyl)-N-methyl ethanolamine, N,N′-bis-(3-aminopropyl)-N,N′-dimethyl ethylenediamine, N,N′-bis-(3-aminopropyl)-piperazine, N-(2-aminoethyl)-piperazine, N,N′-bis-ethoxylpropylenediamine, 2,6-diaminopyridine, diethanolaminoacetamide, diethanolamidopropionamide, N,N-bis-ethoxylphenyl thiosemicarbazide, N,N-bis-ethoxylmethyl semicarbazide, p,p′-bis-aminomethyl dibenzylmethyl amine, 2,6-diaminopyridine, 2-dimethylaminomethyl-2-methylpropane-1,3-diol.

Chain-extending agents containing halogen atoms or R—SO₂O groups capable of quaternization are, for example, glycerol-1-chlorohydrin, glycerol monotosylate, pentaerythritol bis-benzenesulfonate, glycerol monomethane sulfonate, adducts of diethanolamine and chloromethylated aromatic isocyanates or aliphatic haloisocyanates, such as N,N-bis-hydroxyethyl-N′-m-chloromethyl phenyl urea, N-hydroxyethyl-N′-chlorohexyl urea, glycerol monochloroethyl urethane, bromoacetyl dipropylene triamine, chloroacetic acid diethanolamide. Preferred chain-extending agents are short-chain isocyanate-reactive diamines and/or dihydroxy compounds.

In the preferred chain-extending reaction with water, the isocyanate groups initially react with water and form amino groups which then react off with other isocyanate groups. Other preferred chain-extending agents are polyamines.

Suitable methods for preparing polyurethane dispersions are described, for example, in D. Dieterich, Angew. Makromol. Chem. 98, page 133 (1981), Ullmann, Encyklopadie der technischen, Chemie, 4th Edition, Vol. 19, Verlag Chemie, Weinheim/Bergstraβe 1974, pp. 311-313, Houben-Weyl, Methoden der organischen Chemie, Vol. E 20/Part 1-3, pp. 1659-1663 and pp. 1671-1681 and in Journal of Waterborne Coating, August 1984, pages 2 et seq. The secondary literature references cited in these articles also encompass the corresponding patent literature on the subject. As known from EP 354 471 cited above, suitable polyurethane dispersions can be produced by the so-called acetone process. In this case, additions of low boiling solvents, such as acetone for example, are necessary inter alia to reduce the viscosity of the prepolymer so that it can be handled and, hence, ultimately dispersed. In view of the need for solventless products, the disadvantage of processes such as these is that dispersion has to be followed by a technically elaborate distillation step for removing at least most of the low-boiling solvent. This means an additional process step which not only complicates the process, but also adds to the cost of the product, not least because the acetone preferably used cannot readily be returned to the process since anhydrous acetone is preferably used. So far as the expert is concerned, this is also linked inter alia with the question of whether and, if so, to what extent a residual solvent content is acceptable because this determines the cost of the process. However, this conflicts with the need for a solventless product.

The polyurethane prepolymers according to the invention can be produced without solvents. In other words, the reaction of reactants (I) to (IV) to form the reaction products and dispersion of the prepolymer phase can be carried out in the absence of inert solvents. To this end, the reactants (I) to (III) described above are normally mixed at room temperature. The reaction may generally be carried out in typical tank reactors. The reaction temperature is in the range from about 90° C. to 120° C. The reaction mixture may contain additions of catalysts effective for polyurethane reactions. The reaction mixture is normally stirred until the desired NCO content has been established. The dispersion in water is followed by reaction with the aminoalcohols (IV) which react off at least partly with the NCO groups of the prepolymers. The reaction may be carried out by the so-called one-reactor method or even by the so-called two-reactor method. In the first method, which is preferred for the purposes of the invention, the polyurethane prepolymer is dispersed with the quantity of base, for example sodium hydroxide, required for neutralization with vigorous stirring and with introduction of water. On the other hand, however, the prepolymer phase may be introduced into the aqueous base solution and dispersed therein with vigorous stirring. In both cases, dispersion may be carried out at elevated temperatures. The aminoalcohols (IV) may also be combined with the NCO-functional prepolymers in admixture with the water or with the aqueous neutralizing agent. The dispersion step is optionally followed by stirring for 1 to 3 hours, optionally with chain extension by water via remaining NCO groups. The solids content of the dispersions may be adjusted over a wide range, for example from 25 to 50% by weight solids. The polyurethane dispersions used as reaction component (A) normally have a solids content of about 40% by weight.

To form a two-component reactive system, the polymer dispersions described above may contain as reactive component (B) polyfunctional compounds which are capable of reacting off with the functional groups of the polyurethane prepolymers of reactive component (A). The resin component (A) according to the invention may be reacted with a relatively broad range of curing agents including, for example. isocyanates, epoxides, polyethylene imines or triaceridines and melamine/formaldehyde systems. Any acid groups present in the prepolymer may also be bridged by polyvalent ions, more particularly polyvalent heavy metal ions, such as zinc or zirconium for example. These polyvalent cations may thus be regarded as polyfunctional compounds. However, reactive component (B) preferably contains reactive poly-functional organic compounds. Polyfunctional isocyanates are preferred. This of advantage particularly when coatings or laminates, preferably film laminates, are to be produced at relatively low temperatures. of the substances suitable as curing agents, those which can be finely dispersed in the resin component (A), preferably in stable form, are preferred. In the ideal case, these substances may also form a stable aqueous dispersion.

The reactive terminal OH groups of the polyurethane prepolymers are particularly accessible to curing by addition of polyisocyanate compounds. The prepolymers used in an aqueous dispersion of reaction component (A) preferably have a content of isocyanate-reactive groups, expressed as OH functions, of about 0.2 to 1.0% by weight. A content of 0.4 to 0.6% by weight is particularly suitable.

Reactive component (B), the curing agent, preferably consists at least predominantly of polyisocyanates (V) dispersible in water. Isocyanates such as these are already known to the expert, for example from D. Dieterich, Chemie in unserer Zeit 24, (1990), 135 to 141. Water-dispersible aliphatic HDI triisocyanurates are particularly suitable substances for the purpose in question. In addition, triglycidyl isocyanurate may advantageously be used. Also suitable are compounds in which solid crystalline diisocyanate is surrounded by a thin anti-diffusion layer which suppresses any further polyaddition at room temperature. A diisocyanate particularly suitable for this process is N,N′-bis-(2-isocyanatotolyl)-urea (TDIH), which may be prepared from an emulsion of tolylene diisocyanate (TDI) in water. By conducting the reaction in a particular manner, the terminal isocyanate groups inside the particles remain intact. It is only when the anti-diffusion layer is destroyed thermally or mechanically that these isocyanate groups can react off, for example with reactive component (A). According to the invention, (V) preferably consists at least predominantly of HDI polyisocyanurates and/or HDI biuret isocyanates. The ratio of (A) to (B) may be varied over a wide range. However, (B) is normally present in a stoichiometric excess. A particularly favorable film-forming addition ratio is obtained with a 1.2 to 2.5-fold stoichiometric excess of (B).

The present invention also relates to a process for the production of the polymer dispersions according to the invention containing components (A) and (B). This process for the production of the two-component reactive systems is characterized in that the reactive polyfunctional compounds suitable as curing agent are dispersed in resin component (A) in finely divided and preferably stable form. In one particular embodiment of the process according to the invention, the polyfunctional reactive compounds suitable as curing agent are first dispersed in an aqueous medium and the resulting dispersion is thoroughly mixed with the resin component (A). Polyfunctional isocyanates, particularly those which form stable dispersions in water, are preferably used in the process described above.

Since reactive component (B) can also be dispersed in aqueous medium, preferably in the absence of solvent, a totally solvent-free two-component reactive system can be obtained. In addition to the constituents already mentioned, the dispersions according to the invention may contain typical additives known to the expert on polymer dispersions, such as catalysts, wetting agents, foam inhibitors, flow control agents, fillers, pigments, dyes, thickeners and the like.

The present invention also relates to the use of the polymer dispersion suitable as resin component or rather to the use of the two-component reactive systems.

The two-component reactive systems according to the invention are eminently suitable for the surface bonding of substrates. Suitable substrates are, for example, woven fabrics, nonwovens, paper, cardboard, plastics and also metals. For bonding, the reactive components (A) and (B) may first be mixed together and then applied to at least one of the substrates. However, it can also be of advantage successively to apply the two reactive components to at least one of the substrates. In special cases, it can be of advantage to apply reactive component (A) to a substrate and to apply reactive component (B) to another substrate, after which the two substrates are fitted together. The reactive components may be applied by spray coating, spread coating, knife coating and/or roll coating. The reactive adhesives according to the invention are particularly suitable for bonding substrates in the form of films, particularly plastic films and/or metal foils. By this is meant in particular the lamination of films, i.e. the production of multilayer films. The reactive adhesives according to the invention may be used similarly to, or in the same way as, hitherto known two-component film laminating adhesives. They are suitable for laminating machines. The adhesives are normally cured and dried at ambient temperature, i.e. generally at temperatures of 20° C. to 40° C. However, they may also be cured and dried at higher temperatures. Accordingly, the products thus formed, i.e. the laminated films or laminates, contain the two-component reactive system according to the invention and hence resin component (A) in fully reacted, i.e. cured, form. These laminated films are distinguished by good to excellent optical properties, high resistance to water and good to excellent adhesion values.

The two-component reactive systems according to the invention are also suitable for the coating of substrates, more particularly the substrates mentioned above. The systems according to the invention may also be used, for example, as adhesives or paint binders.

The invention is illustrated by the following Examples.

### EXAMPLES

### Example 1

255.1 g of a linear polyester consisting of the components adipic acid and diethylene glycol (OH value 57 mg KOH/g), 14.2 g dimethylol propionic acid and 69 g m-tetramethyl xylylene diisocyanate were reacted for 1.5 h at 110° C. In that time, the NCO content fell to 1.28%. A mixture of 4.24 g NaOH in 650 g water was then introduced with rapid stirring into the reaction mixture which had a temperature of approx. 100° C. An opaque dispersion had formed after about 10 minutes. 7.44 g diglycol amine were then added at a mixing temperature of 52° C., followed by chain extension with stirring for 2 h at 80° C. via the reaction NCO content.

### Product Data of the Polymer Dispersion (Resin Component)

Solids content: 35% by weight

pH value: 7.35

Viscosity: 23 secs., DIN 4 mm cup, 20° C.

Appearance: opaque to clear

Film on Teflon substrate: clear, tacky

### Curing

Curing agent: dispersible polyfunctional aliisocyanate containing 18.5% by weight NCO (HDI biuret triisocyanate)

Mixing ratio: resin component to curing agent=100:6 parts by weight

Film on Teflon substrate tack-free:crosslinked after 1 day

### Example 2

236 g of a linear polyester consisting of the components adipic acid, diethylene glycol, neopentyl glycol and hexane-1,6-diol (OH value 58 mg KOH/g), 16.35 g dimethylol propionic acid and 77.39 g m-tetramethyl xylylene diisocyanate were reacted as in Example 1 for 1.5 hours at 110° C.

At an NCO content of 1.91%, 4.88 g NaOH dissolved in 650 g distilled water were introduced into the reaction mixture (temperature approx. 100° C.) with rapid stirring, resulting in the formation of an opaque to slightly milky dispersion. After stirring for 10 minutes, 15.37 g diethanolamine were stirred into the dispersion cooled to 55° C., followed by stirring for another hour at 70° C.

### Product Data of the Polymer Dispersion (Resin Component)

Solids content: 35% by weight

pH value: 7.4

Viscosity: 21 secs., DIN 4 mm cup, 20° C.

Appearance: opaque, slightly milky

Film on Teflon substrate: clear, tacky

### Curing

Curing agent: dispersible polyfunctional aliphatic isocyanate containing 18.5% by weight NCO (HDI biuret triisocyanate)

Mixing ratio: resin component: curing agent=100:7.5 parts by weight

Film on Teflon substrate: clear, tack-free crosslinked film after 1 day

### Example 3

250 g of a polyester of adipic acid, isophthalic acid and diethylene glycol (OH value 57.5 mg KOH/g), 125 g of a polyester consisting of adipic acid and diethylene glycol (OH value 61 mg KOH/g), 22.4 g dimethylol propionic acid and 110.75 g m-tetramethyl xylylene diisocyanate were reacted with stirring for 3 h at 96° C. as in Example 1. At an NCO content of 1.49%, 6.9 g NaOH dissolved in 720 g distilled water were introduced with rapid stirring. After stirring for about 10 minutes, 5.5 g ethanolamine were added and the remaining NCO was chain-extended with water for 2 h at 70° C.

### Product Data of the Polymer Dispersion (resin component)

Solids content: 42.0% by weight

pH value: 7.45

Viscosity: 535 mPas (Brookfield LVT, Sp. 2, 30 r.p.m., 20° C.

Appearance: opaque to clear

Film on Teflon substrate: clear, tacky to blocking

### Curing

Curing agent: polyfunctional aliphatic predispersed isocyanate containing 18.5% by weight NCO, 6.5 parts by weight in 9 parts by weight water (HDI triisocyanurate)

Mixing ratio: resin component to curing agent =100:15.5 parts by weight

Film on Teflon substrate: tack-free, crosslinked, clear

1. An aqueous polymer dispersion suitable as reactive resin component (A) for a two-component reactive system, characterized in that at least 20% by weight of the polymer content emanates from an aqueous dispersion of OH-functional polyurethane prepolymers obtainable by reaction of
a polyol component (I) containing polyester polyols and
compounds containing at least two isocyanate-reactive groups and, in addition, groups capable of salt formation (II) with
a stoichiometric excess of an isocyanate component (III) consisting of at least 20% by weight tetramethyl xylylene diisocyanate (TMXDI),
subsequent dispersion in water and
at least partial reaction of the remaining NCO groups with aminoalcohols (IV) and
if desired, subsequent chain extension.

2. A polymer dispersion as claimed in claim 1, characterized in that the polyester polyols present in polyol component (I) are based on adipic acid and/or phthalic acid as the acid component.

3. A polymer dispersion as claimed in at least one of the preceding claims, characterized in that the polyester polyols are based at least partly on glycol homologs containing ether oxygen as the alcohol component.

4. A polymer dispersion as claimed in at least one of the preceding claims, characterized in that the polyester polyols used for the preparation of the polyurethane prepolymers have a number average molecular weight of 300 to 5,000 and, more particularly, 500 to 3,000.

5. A polymer dispersion as claimed in at least one of the preceding claims, characterized in that (II) consists of carboxylic acid diols, sulfonic acid diamines and/or aminodiols.

6. A polymer dispersion as claimed in at least one of the preceding claims, characterized in that (II) consists at least predominantly of dimethylol propionic acid (DMPA).

7. A polymer dispersion as claimed in at least one of the preceding claims, characterized in that, in addition to TMXDI, the isocyanate component (III) contains HDI, IPDI, XDI, TMDI, TDI, MDI and/or H₁₂MDI.

8. A polymer dispersion as claimed in at least one of the preceding claims, characterized in that the isocyanate component (III) contains at least 30% by weight and preferably at least 50% by weight TMXDI.

9. A polymer dispersion as claimed in at least one of the preceding claims, characterized in that it is substantially free and preferably completely free from solvent.

10. A polymer dispersion as claimed in at least one of the preceding claims, characterized in that, in the reaction of (I) and (II) with (III), the NCO:OH addition ratio is, or less than, 2.0 and, more particularly 1.7, but more than 1.

11. A polymer dispersion as claimed in at least one of the preceding claims, characterized in that the aminoalcohols (IV) have low molecular weights and, in particular, contain from 2 to 40 and preferably from 2 to 12 carbon atoms.

12. A polymer dispersion as claimed in at least one of the preceding claims, characterized in that (IV) consists of monoaminoalcohols.

13. A polymer dispersion as claimed in at least one of the preceding claims, characterized in that the content of (II) in the polyurethane prepolymers is from 1 to 13% by weight, preferably from 2 to 8% by weight and, more preferably, from 3 to 6% by weight, based on solids.

14. A polymer dispersion as claimed in at least one of the preceding claims, characterized in that, in the reaction of the NCO groups with the aminoalcohols (IV), the NCO:NHR addition ratio is in the range from 1:1 to 1:0.1 and preferably in the range from 1:0.7 to 1:0.2.

15. A polymer dispersion as claimed in at least one of the preceding claims, characterized in that the chain extension is carried out with water and/or polyamines.

16. A polymer dispersion as claimed in at least one of the preceding claims, characterized in that, to form a two-component reactive system, polyfunctional compounds capable of reacting off with the functional groups of the polyurethane prepolymers of reactive component (A) are present as reactive component (B).

17. A polymer dispersion as claimed in at least one of the preceding claims, characterized in that (B) contains reactive polyfunctional organic compounds, preferably polyfunctional isocyanates.

18. A polymer dispersion as claimed in at least one of the preceding claims, characterized in that the isocyanates consist at least predominantly of HDI polyisocyanurates and HDI biuret isocyanates.

19. A polymer dispersion as claimed in at least one of the preceding claims, characterized in that (B) is present in a stoichiometric excess of about 1.2 to 2.5-fold over (A).

20. A process for the production of the polymer dispersion claimed in any of claims 16 to 19, characterized in that reactive component (B) is dispersed in finely divided and preferably stable form in a resin component (A) corresponding to any of claims 1 to 15.

21. A process as claimed in the preceding claim, characterized in that reactive component (B) is first prepared by dispersing polyfunctional organic compounds dispersible in water, more particularly isocyanates, in an aqueous medium and then thoroughly mixing the resulting dispersion with the resin component (A).

22. The use of the dispersions claimed in claims 1 to 19 for the surface bonding of substrates.

23. The use of the dispersions claimed in claims 1 to 19 for the bonding of substrates in the form of plastic films or metal foils.

24. The use of the dispersions claimed in claims 1 to 19 for bonding substrates.
